(19) United States
(12) Patent Application Publication
(10) Pub. No.: US 2025/0281984 A1
(43) Pub. Date: Sep. 11, 2025

(54) HOLE SAW WITH AN INTERNAL AUGER

(71) Applicant: Benjamin A. Aloisio, Tacoma, WA (US)

(72) Inventor: Benjamin A. Aloisio, Tacoma, WA (US)

(21) Appl. No.: 18/751,265

(22) Filed: Jun. 23, 2024

Related U.S. Application Data
(63) Continuation-in-part of application No. 18/598,254, filed on Mar. 7, 2024.

(51) Int. Cl. B23B 51/04

(52) U.S. Cl. CPC B23B 51/0467; B23B 51/0473; B23B 51/0453

(57) ABSTRACT

A hole saw for quickly cutting holes through workpieces without stopping to eject cut material. The device includes a cylindrical body with cutting teeth on a first end side engageable with a workpiece and a base plate on a second end side engageable with a power tool. The cylindrical body has one or more discharge slots and a removable internal auger secures to the base plate. The one or more blades of the internal auger and ejection of cut material from any of the discharge slots on the cylindrical body and/or the base plate enable cutting deep holes that are not limited by the depth of the cylindrical body. The removable internal auger allows for maintenance and sharpening for an extended use.

### CROSS-REFERENCE TO RELATED REFERENCES

This continuation in part patent application claims priority to non-provisional patent application Ser. No. 18/598,254 which was filed on Mar. 7, 2024, which is incorporated by reference in its entirety.

### FIELD OF DISCLOSURE

The present invention relates generally to a hole saw and more particularly to a hole saw with an internal auger that cuts larger diameter holes in various materials, such as for plumbing between floors of structures. This improved hole saw cuts deep holes without having to stop during the process of cutting a hole in order to empty out cut material shavings and cores.

### BACKGROUND

Hole saws are a widely used tool to cut holes through workpieces of various materials. A typical hole saw has a cylindrical body with cutting teeth on one end and a base plate on the other end that mounts to an arbor which is connected to a chuck of a power tool, such as a drill. The base provides support for the hole saw and locks onto the arbor. The diameter of the cylindrical body and base plate may range from 9/16 inches to 6 inches. Hole saws can drill holes in drywall, steel, aluminum, wood, and many other materials.

A frequent problem when using hole saws is that during and after a hole has been drilled, the material that has been cut remains trapped or embedded within the cylindrical body of the hole saw, commonly referred to as the plug or core. To aid in removal of the plug, a screwdriver or similar tool may be inserted in the slots on the cylindrical body to push the plug out. Other designs have springs or some other method to push the plug out from the base end. The extra steps required to remove the cut material can be tedious and frustrating.

Additionally, the depth of the hole to cut is controlled by the depth of the hole saw from the teeth to the base. For thicker materials, such as the thickness of a top plate and a double plate layered together in a frame of a structure, 4 inches is thicker than the depth of currently available hole saws. A work around is to cut a hole from one side of the workpiece, stop, remove the trapped material from the inside of the cylinder, cut the workpiece from the other side, stop, and remove the material from the inside of the cylinder again. This can be especially tedious when the workpiece cannot be simply flipped around, such as between floors in a structure (i.e., between the first floor and the second floor). The same problems are encountered especially when drilling through the rim board between floors which can be 12 inches thick.

A further limitation is the difficulty of cutting a fraction of a hole such that the hole overlaps the edge of the material to be cut and the resulting hole is not a complete circular hole. In the building trade, a frequent scenario is the requirement to cut a hole through the edge of a joist or other internal obstruction. Cutting such holes can be difficult because there is no material for a pilot bit to drill into when less than 50% of a complete circular hole needs to be made. Accordingly, there exists a need for a hole saw that improves the process of cutting deep holes and/or fractions of holes without having to force cut material out from the hole saw.

### SUMMARY

The present description includes one or more non-limiting embodiments for a device in the form of a hole saw with an internal auger that cuts large holes through material without having to pause to release cut material from the hole saw and without being limited by the depth of the hole saw. In a non-limiting embodiment, the hole saw with an internal auger comprises a saw folded over into a circle disposed along an axis of rotation with a sidewall extending axially from a base plate. The base plate further comprises discharge slots open towards a connected power tool to kick out the cut material so the driller can continue cutting without having to stop and remove material from the hole saw. The base plate further comprises apertures to accommodate various pins, screws, drill bits, and any other parts of a mandrel connecting the hole saw to the power tool.

In non-limiting embodiments, the hole saw comprises one or more internal augers that are inserted into the hole saw from the side with radially projecting saw teeth until flush with the base plate and set screws are removably screwed in from behind the base plate (the side opposite of the hole saw teeth) to secure the internal auger in the hole saw. Advantageously, the removable internal auger may be removed for maintenance and sharpening or to be replaced with another removable internal auger The internal auger further comprises a blade to cut material and apertures and/or cutouts to accommodate various pins, screws, drill bits, and any other parts of a mandrel connecting the hole saw to the power tool.

In non-limiting embodiments, the internal auger has a thrust lug wherein the thrust lug is a protrusion that extends from the internal auger through a discharge slot on the base plate. In some embodiments, the thrust lug protrudes until flush with a side of the base plate facing the power tool. In other embodiments, the thrust lug protrudes perpendicularly on a side of the base plate facing the power tool. In yet further non-limiting embodiments, the thrust lug protrudes through the base plate and wraps around a side of the base plate facing the power tool in an L-shape. In use, the thrust lug absorbs the impact every time the blade of an internal auger hits material to be cut and helps to keep the internal auger secured to the base plate.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

Other aspects and advantages of the invention will be apparent from the following description and appended claims.

FIG. 1 depicts a pictorial illustration of a non-limiting embodiment of a hole saw from a front perspective view.

FIG. 2 depicts a pictorial illustration of a front view of the hole saw of FIG. 1.

FIG. 3 depicts a pictorial illustration of a cross-sectional view taken at line A-A in FIG. 2.

FIG. 4 depicts a pictorial illustration of a cross-sectional view taken at line B-B in FIG. 2.

FIG. 5 depicts a pictorial illustration of a rear view of the hole saw of FIG. 1.

FIG. 6 depicts a pictorial illustration of a side view of the hole saw of FIG. 1.

FIG. 7 depicts a pictorial illustration of an exploded view of another non-limiting embodiment of a hole saw.

FIG. 8 depicts a pictorial illustration of a cross-sectional view taken through the center of the non-limiting embodiment of the hole saw of FIG. 7.

FIG. 9 depicts a pictorial illustration of a front view of the non-limiting embodiment of the hole saw of FIG. 7 without an internal auger.

FIG. 10 depicts a pictorial illustration of a rear view of the hole saw of FIG. 7 without an internal auger fastened.

FIG. 11A depicts a pictorial illustration of a side view of a non-limiting embodiment of an internal auger with one blade accompanied by one discharge opening.

FIG. 11B depicts a pictorial illustration of a side view of the non-limiting embodiment of the internal auger with one blade in FIG. 11A that is rotated 90 degrees.

FIG. 11C depicts a pictorial illustration of a rear view of the non-limiting embodiment of the internal auger with one blade in FIG. 11A.

FIG. 12 depicts a pictorial illustration of another non-limiting embodiment of a hole saw.

FIG. 13 depicts a pictorial illustration of a cross-sectional view taken through the center of the non-limiting embodiment of the hole saw of FIG. 12.

FIG. 14 depicts a pictorial illustration of a rear perspective view of the hole saw of FIG. 12.

FIG. 15 depicts a pictorial illustration of a front view of the hole saw of FIG. 12.

FIG. 16A depicts a pictorial illustration of a top perspective view of a chipper blade part of the hole saw of FIG. 12.

FIG. 16B depicts a pictorial illustration of a bottom perspective view of a chipper blade part of the hole saw of FIG. 12.

FIG. 17 depicts a box diagram of a hole saw.

### DETAILED DESCRIPTION

The present description is drawn to a novel and unique hole saw that has an internal auger with one or more blades to cut a workpiece and strategically placed holes on the cylinder and the back plate of the hole saw. It is noted that the hole saw may be in different diameters to accommodate different sizes of holes needed to be cut.

In accordance with non-limiting embodiments, the hole saw can be used to cut holes into a variety of materials. The present invention, in particular, cuts larger diameter holes in thick workpieces without having to pause and remove cut material from the hole saw. The hole saw with an internal auger, which may also be referred to as “hole saw” for brevity, may be a device made of one single piece or may be in two pieces where a hole saw piece is fastened to an internal auger piece with set screws rather than welded together in a single piece. In embodiments with two separatable pieces, the internal auger piece may be fastened to a hole saw piece that a user may already have in possession. Alternatively, the internal auger piece may be fastened to a hole saw with slots in the back plate of the hole saw.

While the present invention is particularly suited for cutting large diameter holes for plumbing fixtures between floors of structures, different sized holes may be cut with varying sizes of the hole saw and internal auger.

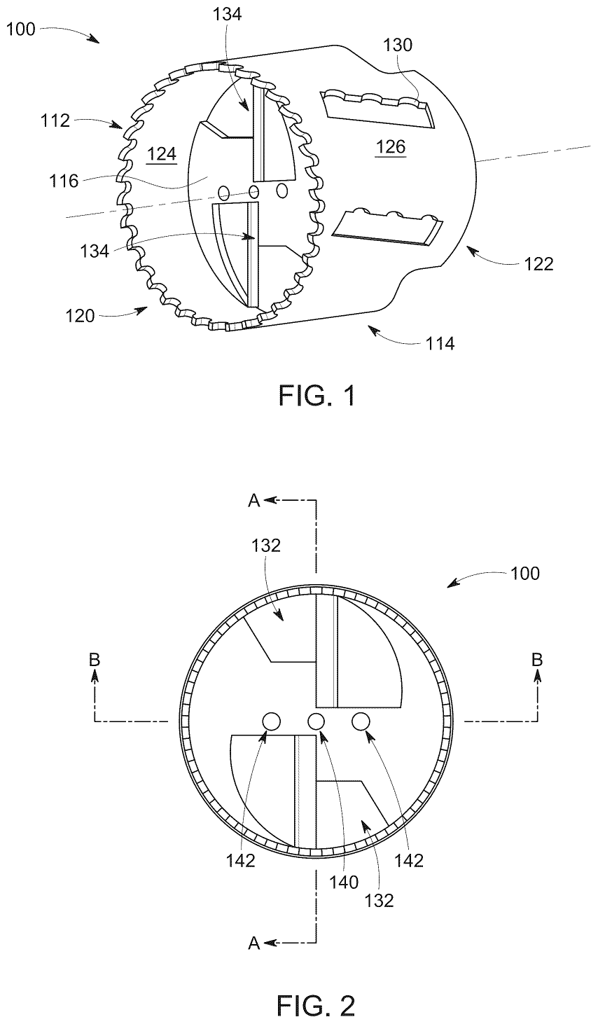

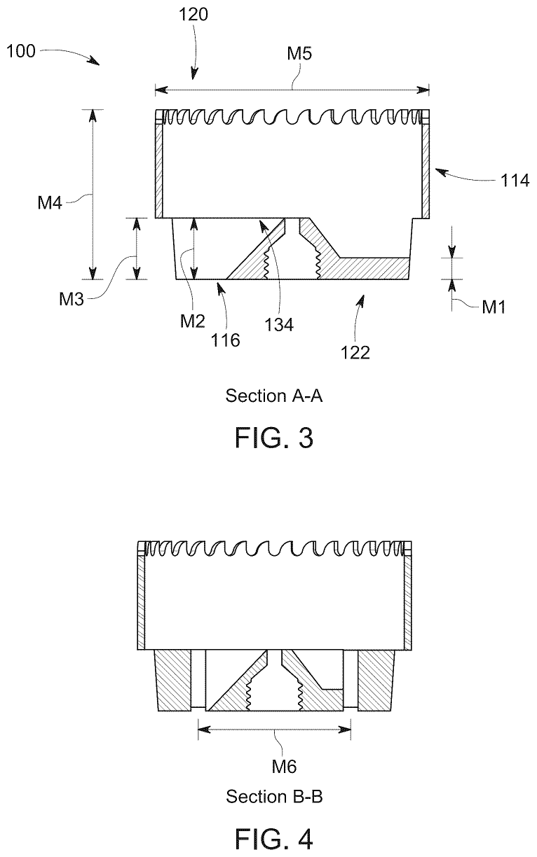

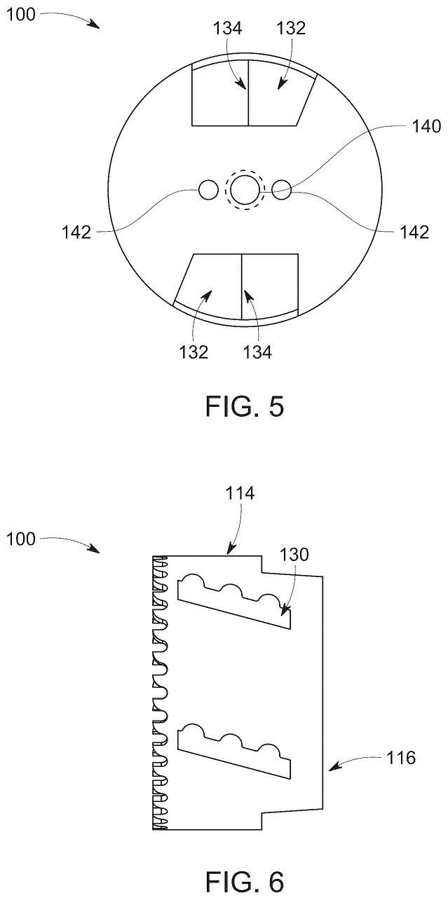

FIG. 1 shows a pictorial illustration of a perspective view of a non-limiting embodiment of a hole saw with an internal auger. In this non-limiting embodiment, the hole saw with an internal auger is one piece that attaches to an arbor for a drill chuck. The hole saw 100 comprises a saw folded over into a circle to form cylindrical body or sleeve 114. Cylindrical body 114 may be made in any method known by those of ordinary skill in the art. Cylindrical body 114 has teeth that extend axially on one side, such as teeth 112 on teeth end 120 of the cylindrical body 114. On the other side of cylindrical body 114 is the base end 122 where the base 116 (as shown in FIG. 3) closes off cylindrical body 114.

In some embodiments, cylindrical body 114 has circumferentially disposed holes or slots 130 that extend from inner surface 124 to outer surface 126 of the cylindrical body 114. Any size, shape, and number of holes or slots 130 may be on cylindrical body 114 to aid in ejection of cut material. In addition to the holes or slots 130 on the cylindrical body 114, there are one or more discharge slots 132 on base 116. Each of the one or more discharge slots 132 (e.g. as shown for example in FIG. 2) is adjacent to a cutting edge or blade 134. In non-limiting embodiments, as shown in FIG. 1, hole saw 100 has two cutting edges 134 and each cutting edge 134 is accompanied by a discharge slot 132 so as to provide a place for cut material to eject out. Discharge slots 132 allow cut material to exit from the hole saw 100 thereby allowing a user to continue cutting through thick workpieces without stopping to empty the hole saw 100 of cut material. When there are two cutting edges 134, as shown in FIG. 1 and FIG. 2, the cutting edges 134 are arranged in diametrically opposed relation to each other. The cutting edges 134 have a blade pitch toward the teeth end 120 to cut into material inside cylindrical body 114 and the pitch naturally guides the cut material to the open discharge slots 132 on the base 116 and out and away from the hole saw 100.

Further, as shown in a non-limiting embodiment in FIG. 1, base 116 has a central, threaded bore 140 to screw hole saw 100 onto an arbor. Surrounding central bore 140 are holes or apertures 142 that correspond to drive pins from an arbor. Apertures 142 may be positioned to accommodate the locations of drive pins on different arbors. A pilot bit or self-feeding bit may be inserted in central bore 140 to assist in guiding the cutting of the hole. When desired, such as when cutting fractions of holes, especially holes that are less than 50% of a circle, the pilot bit may be removed to insert a shorter bit or to have no bit. Without a pilot bit, the structure of the teeth 112 and cylindrical body 114 hold the hole saw 100 in position as cutting edge 134 cuts material from the workpiece and ejects the cut pieces out from slots 130 and/or discharge slots 132. The hole saw teeth 112, 212 and the core or plug within the hole saw 100, 200 (before the plug is cut with the cutting edges 134, 250 of the internal auger) keep the hole saw 100, 200 from deflecting towards the edge of the workpiece.

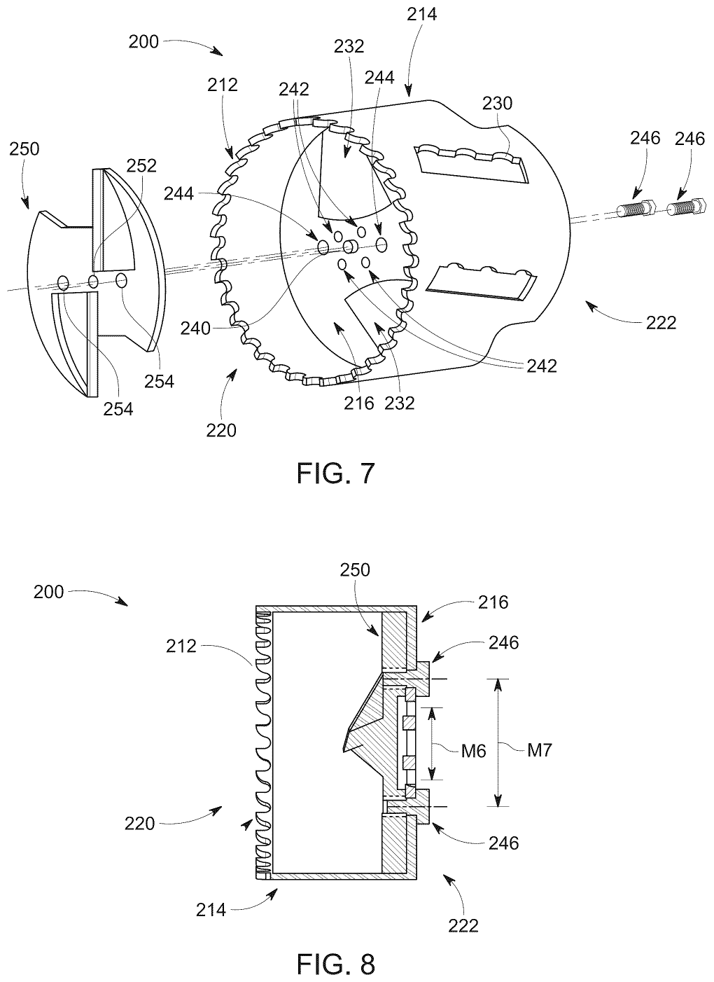

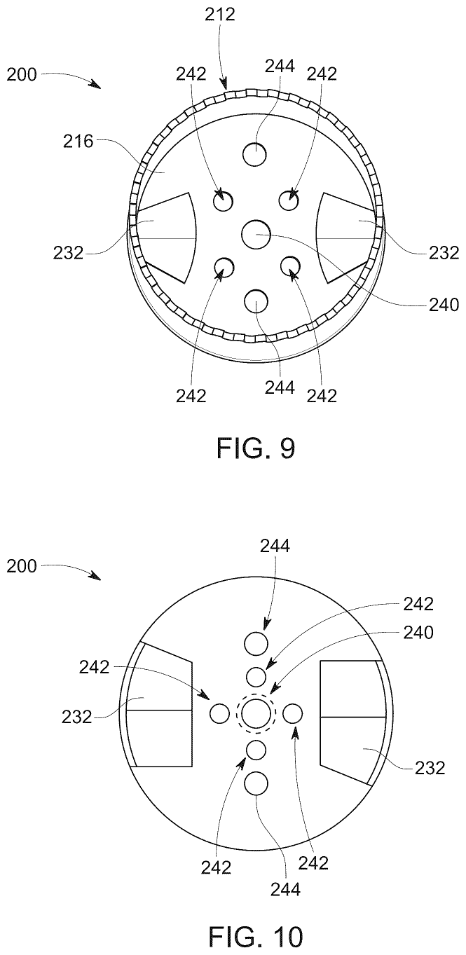

In another non-limiting embodiment, hole saw 200 comprises two pieces as can be seen in FIG. 7. One piece of hole saw 200 comprises a cylindrical body or sleeve 214 with a base 216. Similarly to the hole saw 100 in FIG. 1, hole saw 200 has teeth 212 that extend axially on the teeth end 220 of cylindrical body 214. Additionally, base 216 is on base end 222 of cylindrical body 214 opposite of teeth end 220. There is one or more holes or slots 230 circumferentially disposed on cylindrical body 214 to aid in removal of cut material. Slots 230 may be of any size, shape, number, and location on cylindrical body 214 as long as the holes or slots 230 do not hinder or weaken hole saw 200. The base 216 of cylindrical body 214 also has discharge slots 232 to further aid in the ejection of cut material. Base 216 has a threaded, central bore 240 to screw cylindrical body 214 on to an arbor for a drill chuck. Surrounding central bore 240 are holes or apertures 242 that correspond to drive pins on an arbor to be connected to a drill chuck. Additionally, base 216 has holes 244 for set screws to secure the internal auger or blade head 250 to cylindrical body 214, which will be further explained below.

Hole saw 200 also comprises a second piece: the internal auger or blade head 250. Blade head 250 comprises a center bore 252 for a pilot bit or any other drill bit to go through when the arbor is connected. Internal auger 250 also has threaded holes 254 corresponding to holes 244 on cylindrical body 214 for set screws 256. Blade head 250 has one or more cutting edges like hole saw 100 to cut material.

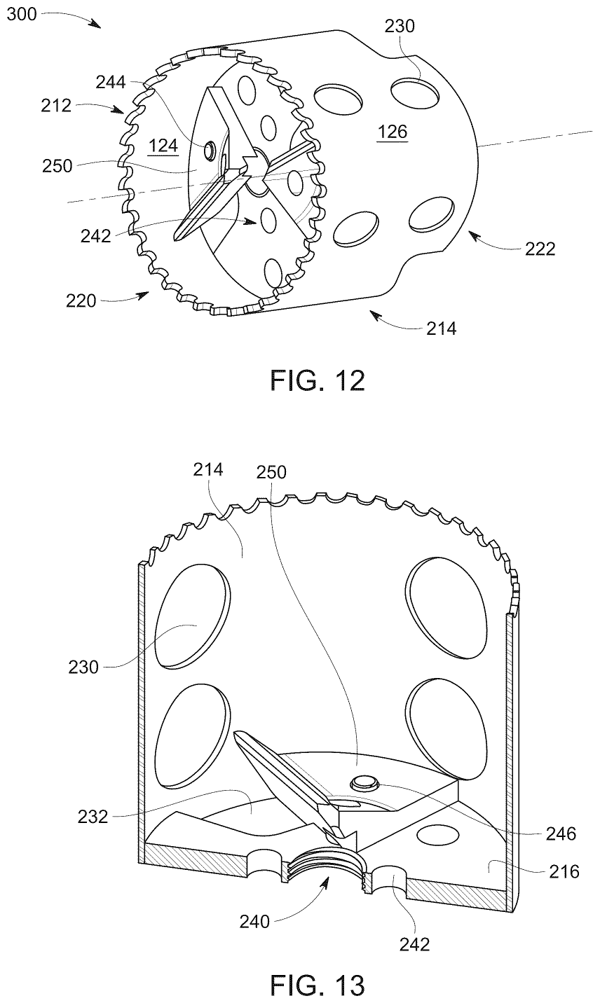

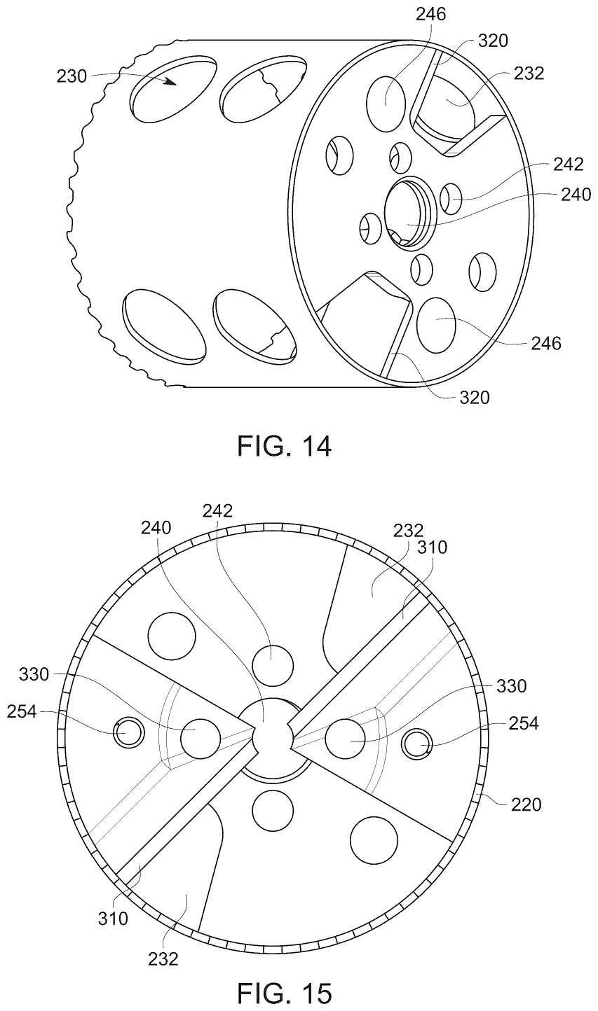

FIG. 12 shows a front perspective view of another non-limiting embodiment of a hole saw, labeled as hole saw 300 purely for ease in disclosing the details of this embodiment but functions similarly to hole saw 100, 200 to cut through thick material. Hole saw 300 is similar to hole saw 200 in that the cutting element via internal auger 250 is removably fastenable to cylindrical body 214. Removability of internal auger 250 allows for flexibility in the use of different internal augers 250, differing number of internal augers 250, and different styles of hole saws 200, 300 by different manufacturers. Removability also allows for internal auger 250 to be maintained and sharpened, significantly extending the life of the blade as opposed to nonremovable or permanently affixed internal augers 250.

As seen in FIG. 12 and in the cross-sectional view in FIG. 13, internal auger 250 is secured to base 216 with set screw 246 in holes for set screws 244, 254. Internal auger 250 covers a smaller portion of base 216 and covers less than or up to the radius of base 216 such that internal auger 250 does not require a passageway through internal auger 250 but only requires a cut out portion or shaped to allow a drill bit to pass through threaded bore 240 of base 216 when a user desires to use a drill bit. Additionally, due to the smaller size, a user may secure more than one internal auger 250 to base 216 as allowed based on the configuration of discharge slots 232, holes 242 for drive pins, and holes 244 for set screws. In other embodiments, internal auger 250 may be just large enough to comprise a threaded bore 240 to allow a drill bit to pass through when a user so desires.

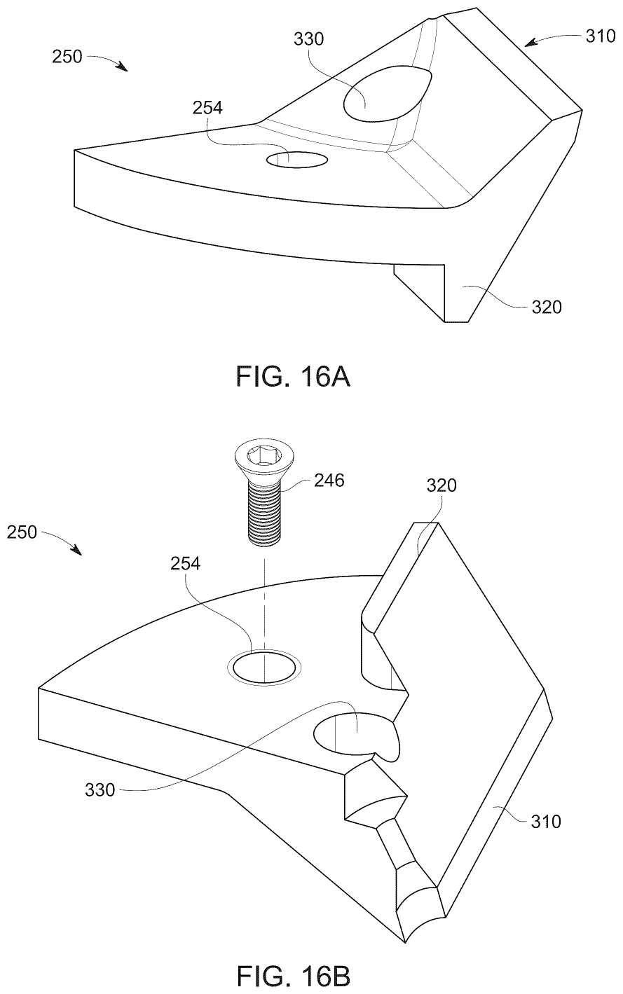

FIG. 16A and FIG. 16B illustrate top and bottom perspective views of a non-limiting embodiment of internal auger 250, respectively. Internal auger 250 comprises a blade edge 310, hole 330 for a drive pin on a mandrel to protrude into, threaded hole 254 for a set screw 246, and thrust lug 320. Notably, the internal auger 250 in FIG. 16A and FIG. 16B covers a smaller area of base 216 as discussed above. Due to the smaller size of internal auger 250 in FIG. 16A and FIG. 16B, threaded bore 240 on base 216 is not covered and therefore there is no bore 252 on internal auger 250 but rather some portions cut out or removed, as best seen in FIG. 16B, to allow for a drill bit to pass through for when a user desires to use a drill bit with hole saw 300. The internal auger 250 is shown to have one hole 244 for one set screw 246 for securing to base 216. However, internal auger 250 may cover a larger area that contacts base 216 in order to accommodate more than one hole 244 and corresponding set screw 246 to secure internal auger 250 onto base 216 at a greater strength for stability.

Internal auger 250 in FIG. 16A and FIG. 16B also shows thrust lug 320, which is a portion of internal auger 250 that projects through discharge slots 232 on base 216 towards the user or power tool while in use for greater security and stability when internal auger 250 is secured to base 216. Thrust lug 320 may project until flush with the rear side of base 216 or further such as to stick out from the rear side of base 216. When sticking out, thrust lug 320 may protrude perpendicularly or form a, L-shaped bend so as to overlap or wrap around the rear side of base 216, which may provide even further stability when internal auger 250 encounters strong forces while chipping away material. Regardless of shape, thrust lug 320 is designed to absorb the impact every time blade edge 310 hits material to be cut. In further embodiments, there may be no thrust lug 320 such that there is no protrusion. The absence of a thrust lug 320 is discussed further below.

In other non-limiting embodiments, internal auger 250 may be secured to a hole saw that a user already has in possession. In this case, internal auger 250 has threaded holes 254 located to correspond with holes on the hole saw in possession. The threaded holes 254 may be positioned as shown in FIG. 7 for cylindrical body 214. Threaded holes 254 may be positioned differently than in FIG. 7 to correspond with different designs of hole saws from different manufacturers. Internal auger 250 as a second piece is advantageously designed to fit holes saws a user already has in possession for flexibility and convenience such that the user does not have to acquire multiple parts that have the same functionality but different placement of holes.

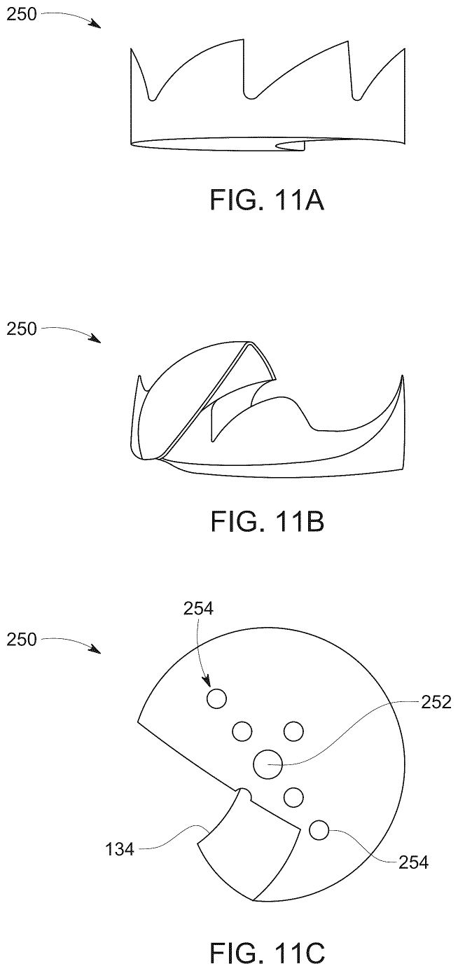

In some non-limiting embodiments, as shown in FIG. 11A, FIG. 11B, and FIG. 11C, internal auger 250 has a single cutting edge with an accompanying opening to allow cut material to eject out from discharge slots 232 on base 216. Alternatively, when internal auger 250 is fastened to a hole saw that the user already has in possession, this hole saw likely does not have discharge slots 232 on the base of cylindrical body 214. In such cases, cut material exits out from holes or slots 230 on the cylindrical body 214. In other nonlimiting embodiments, internal auger 250 as shown in FIG. 16A and FIG. 16B but without thrust lug 320 may be used on a hole saw with no discharge slots in the base of the hole saw. The internal auger 250 shown in FIG. 16A and FIG. 16B without thrust lug 320 would have no protrusion and allow internal auger 250 to sit flush on the base of hole saw with no discharge slots 232. Hole saw 200, 300 with any number of blades functions and has advantages as discussed for hole saw 100.

In use, internal auger 250 is inserted into cylindrical body 214. The internal auger 250 or cylindrical body 214 is rotated or manipulated until holes 244 and holes 254 align. If there is a thrust lug 320, then thrust lug 320 must protrude through a discharge slot 232 as part of manipulation of internal auger 250 for alignment. Once aligned, set screws 246 are screwed in from the rear of base plate 216 to secure internal auger 250 to cylindrical body 214. FIG. 8 shows hole saw 200 with internal auger 250 secured to cylindrical body 214 with set screws 246.

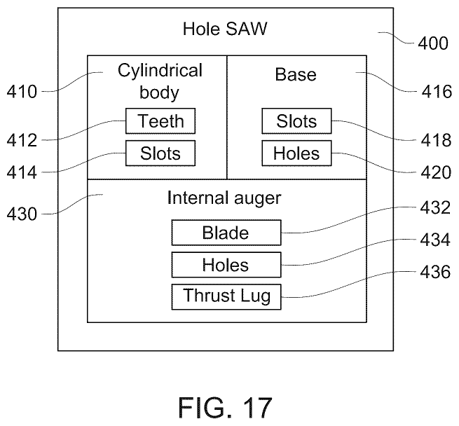

FIG. 17 illustrates a box diagram of the hole saw with internal auger. Hole saw 400 is illustrated to comprise a cylindrical body or sleeve 410, a base 416, and internal auger 430. Cylindrical body 410 and base 416 are pieces that are fused together or created as a single piece. Internal auger 430 may be incorporated into base 416, permanently affixed to base 416, or be removably fastened to base 416. Cylindrical body 410 is shown to comprise teeth 412 for cutting and slots 414 to aid in discharge of cut material. Base 416 is shown to comprise discharge slots 418 and holes 420 for various screws, pins, drill bits, etc. There may be zero or more discharge slots 418 depending on the hole saw a user has on hand. There may be any number of holes 420 in different configurations to accommodate use of different mandrel designs and different internal augers 250 with differing numbers of screws and pins.

FIG. 17 also illustrates internal auger 430 as comprising blade 432, holes 434, and thrust lug 436. Internal auger 430 has at least one blade 432 to cut material within the cylindrical body 410 of the hole saw 400. There could be one internal auger 250 with one or more blades. Alternatively, there could be more than one internal auger 250, each with a single blade. Like holes 420 in base 416, internal auger 250 has holes 434 for various screws, pins, drill bits, etc. There may be any number of holes 434 in different configurations for flexibility in positioning internal auger 250 on base 416 and to accommodate use of different mandrel designs and different base 416 designs with differing numbers of screws and pins.

The side of internal auger 430 that contacts base 416 sits flush with each other. Internal auger 430 may comprise a thrust lug 436 which projects through slots 418 of base 416. Thrust lug 436 may have different designs but is generally shaped perpendicularly through a slot 418 to absorb force when cutting material hits blade 432 and aids in keeping internal auger 430 securely in place. An example design of thrust lug 436 comprises a projection projecting through a slot 418 and then wrapping around base 416 in an L-shape such that a part of the thrust lug 436 projection sandwiches or hooks a small portion of base 416.

Throughout FIG. 3, FIG. 4, and FIG. 8 show exemplary hole saws 100, 200 with some exemplary, non-limiting measurements for clarification. In a non-limiting embodiment, measurement M1 for the thickness of base plate 116 may be approximately ⅜ of an inch (0.952 cm) thick. The measurement M2 for the height of blade 134 may be approximately one inch. The measurement M3 for the height from base 116 to the top of central bore 140 may be approximately one inch. The measurement M4 for the dimension from teeth 112 to base 116 may be approximately 2.5 inches. The measurement M5 for the diameter of hole saw 100 may be approximately 4.25 inches. The measurement M6 for the distance between holes 242 for the drive pins on an arbor may be approximately one inch. The measurement M7 for the distance between holes 244 for set screws 246. It is to be understood that the different measurements may be different as the hole saw 100, 200 is scaled smaller or larger to cut different sized holes in workpieces.

Advantageously, the hole saw 100, 200, 300 described above and shown in the figures may be used to cut deep holes without needing to pause to remove cut material from the hole saw. The hole saw 100, 200, 300 easily cuts through 12-inch-thick material without being limited by the depth of the hole saw itself. As noted above, the unique features of the hole saw 100, 200 with an internal auger remove the tedium and extra time taken to remove cut and trapped material within currently available hole saws. Hole saw 100, 200, 300 also cuts fractions of holes when there is no material for a pilot bit or self-feeding bit to drill into. While preferred and non-limiting embodiments of the present invention have been described, various other adaptations and modifications may be envisioned by those of ordinary skill in the art without departing from the scope and spirit of the invention. Many other advantages and benefits may be provided by the one or more systems and components described herein.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. (canceled)

2. (canceled)

3. (canceled)

4. (canceled)

5. (canceled)

6. (canceled)

7. (canceled)

8. (canceled)

9. (canceled)

10. A hole saw assembly comprising:
a cylindrical body having a first end with cutting teeth for cutting a workpiece and a second end opposite the first end,
wherein the cylindrical body includes an inner surface and an outer surface;
a base secured to the second end of the cylindrical body, the base including a central bore and at least one discharge slot configured to eject material cut by the hole saw;
an internal auger blade positioned within the cylindrical body, the internal auger blade having a cutting edge, wherein the cutting edge includes a blade pitch toward the cutting teeth to cut into material inside the cylindrical body and the pitch naturally guides the cut material to an open discharge slot on the base and out and away from the hole saw; and
a shank extending from the base, the shank being integrally formed with the base or configured to attach to an arbor, wherein the shank is configured for attachment to a drill chuck, thereby providing increased durability and stability during operation,
wherein the internal auger blade is configured to guide cut material toward the at least one discharge slot in the base for ejection, allowing the hole saw assembly to cut through thick materials without interruption for material removal.

11. The hole saw assembly of claim 10, wherein the cylindrical body further comprises a plurality of circumferentially disposed holes or slots extending from the inner surface to the outer surface, configured to assist in the ejection of cut material from within the cylindrical body.

12. (canceled)

13. The hole saw assembly of claim 10, wherein the internal auger blade is configured with a plurality of cutting edges, each cutting edge being accompanied by a corresponding discharge slot in the base for enhanced material ejection.

14. The hole saw assembly of claim 10, further comprising a thrust lug configured to project through the discharge slot on the base, wherein the thrust lug of the internal auger blade extends flush with or beyond the rear side of the base, providing additional stability when encountering strong cutting forces.

15. The hole saw assembly of claim 10, wherein the base includes a plurality of apertures surrounding the central bore, each aperture configured to accommodate drive pins from different arbor designs, enhancing compatibility with various drill setups.

16. The hole saw assembly of claim 10, wherein the central bore of the base is threaded to accept a pilot bit or self-feeding bit, providing additional guidance during the cutting process.

17. The hole saw assembly of claim 10, wherein the shank is configured with anti-slip features, such as knurled surfaces or flat sections, to enhance grip and prevent slippage when secured in a drill chuck.

18. (canceled)

19. The hole saw assembly of claim 10, wherein the cutting teeth on the first end of the cylindrical body project both axially and radially.

20. The hole saw assembly of claim 10, wherein the internal auger has a shape that allows a drill bit to pass through the base plate without the internal auger itself having a central bore.

21. The hole saw assembly of claim 10, wherein the internal auger, during use, sits flush against the base plate when inserted into the cylindrical body.

22. The hole saw assembly of claim 10, wherein the internal auger comprises a thrust lug configured to extend flush with the side of the base plate facing the power tool.

23. The hole saw assembly of claim 22, wherein the thrust lug on the internal auger protrudes perpendicularly on the side of the base plate facing the power tool.

24. The hole saw assembly of claim 23, wherein the thrust lug on the internal auger wraps around the side of the base plate in an L-shape to provide additional stability during operation.

25. The hole saw assembly of claim 10, wherein the internal auger comprises one or more apertures that allow drive pins on the arbor to pass through when the internal auger is secured to the base plate.

26. The hole saw assembly of claim 10, wherein the shank is integrally formed with the base, providing a permanent connection to the base and enhancing durability and stability during cutting operations.

27. The hole saw assembly of claim 10, wherein the shank is configured to attach to the arbor, allowing the hole saw assembly to be used with various drill setups by engaging with drive pins on the arbor.

28. The hole saw assembly of claim 10, wherein the internal auger blade is removably fastened to the base via a screw extending through corresponding threaded holes in the internal auger blade and the base, and wherein the screw engages both the base plate and the internal auger, securing them together.

29. The hole saw assembly of claim 10, wherein the internal auger blade is permanently affixed to the base by welding, providing a fixed and durable connection that enhances stability during cutting operations.
